(19) United States
(12) Patent Application Publication
(10) Pub. No.: US 2007/0185266 A1
(43) Pub. Date: Aug. 9, 2007

(54) Non-aqueous, liquid coating compositions curable by free-radical polymerization of olefinic double bonds

(76) Inventors: Carmen Flosbach, Wuppertal (DE); Tanja Renkes, Essen (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/349,488

(22) Filed: Feb. 7, 2006

(51) Int. Cl. C08F 8/30

(52) U.S. Cl. 525/127

(57) ABSTRACT

Non-aqueous, liquid coating compositions curable by free-radical polymerization of olefinic double bonds with a resin solids content consisting of 50 to 100 wt. % of a binder solids content curable by free-radical polymerization of olefinic double bonds, 0 to 30 wt. % of one or more crosslinking agents C and 0 to 50 wt. % of one or more components D, wherein the weight percentages add up to 100 wt. %, wherein the binder solids content consists of above 95 wt. % to 99.5 wt. % of one or more components A curable by free-radical polymerization of olefinic double bonds and 0.5 to below 5 wt. % of one or more polyurethane resins B curable by free-radical polymerization of olefinic double bonds, wherein the weight percentages of the at least one component A and the at least one polyurethane resin B add up to 100 wt. %, wherein the at least one component A is liquid and/or is present in dissolved form and wherein the at least one polyurethane resin B is present as particles having a melting temperature of 40 to 160° C.

### FIELD OF THE INVENTION

The invention relates to novel non-aqueous, liquid coating compositions curable by free-radical polymerization of olefinic double bonds.

### DESCRIPTION OF THE PRIOR ART

Non-aqueous, liquid coating compositions curable by free-radical polymerization of olefinic double bonds are known per se. The only examples, which will be mentioned here, are those UV-curable clear coating compositions known for use as automotive clear coats, such as, those known, for example, from EP-A-0 540 884, WO 01/24946, U.S. Pat. Nos. 5,425,970 and 6,261,645.

It has now been found that the per se known non-aqueous, liquid coating compositions curable by free-radical polymerization of olefinic double bonds may be improved if they contain, apart from the hitherto conventional components curable by free-radical polymerization of olefinic double bonds, a small amount of a specific kind of polyurethane resin curable by free-radical polymerization of olefinic double bonds. In this way, it is possible to achieve improved cheological properties, for example, improved sagging properties even at elevated temperatures.

### SUMMARY OF THE INVENTION

The invention is directed to non-aqueous, liquid coating compositions curable by free-radical polymerization of olefinic double bonds with a resin solids content consisting of 50 to 100 wt. % of a binder solids content curable by free-radical polymerization of olefinic double bonds, 0 to 30 wt. % of one or more crosslinking agents C and 0 to 50 wt. % of one or more components D, wherein the weight percentages add up to 100 wt. %, wherein the binder solids content consists of above 95 wt. % to 99.5 wt. % of one or more components A curable by free-radical polymerization of olefinic double bonds and 0.5 to below 5 wt. % of one or more polyurethane resins B curable by free-radical polymerization of olefinic double bonds, wherein the weight percentages of the at least one component A and the at least one polyurethane resin B add up to 100 wt. %, wherein the at least one component A is liquid and/or is present in dissolved form and wherein the at least one polyurethane resin B is present as particles having a melting temperature of 40 to 160° C.

### DETAILED DESCRIPTION OF THE EMBODIMENTS

The coating compositions according to the invention are liquid and have a solids content of, for example, 40 to 100 wt. %, preferably of 45 to 85 wt. %.

The solids content of the coating compositions according to the invention consists of the resin solids content and the following optional components: pigments, fillers (extenders) and non-volatile additives.

The resin solids content of the coating compositions according to the invention consists of 50 to 100, preferably 70 to 100 wt. % of the binder solids content consisting of components A and B, 0 to 30 wt. % of one or more crosslinking agents C and 0 to 50 wt. % of one or more components D, wherein the weight percentages add up to 100 wt. %.

The binder solids content consists of above 95 to 99.5 wt. %, preferably above 95 to 99 wt. %, of at least one component A curable by free-radical polymerization of olefinic double bonds and 0.5 to below 5 wt. %, preferably 1 to below 5 wt. %, of at least one polyurethane resin B curable by free-radical polymerization of olefinic double bonds.

The components A are conventional binders A1 and/or reactive diluents A2, in each case having free-radically polymerizable olefinic double bonds and in each case being liquid and/or soluble in an organic solvent (mixture), i.e., if the coating compositions contain organic solvent(s), the components A are present in the coating compositions in dissolved form.

Suitable binders A1 with free-radically polymerizable olefinic double bonds, which may be considered are, for example, conventional binders known to the person skilled in the art which can be crosslinked by free-radical polymerization. These binders are prepolymers, such as, polymers and oligomers containing, per molecule, one or more, preferably on average 2 to 20, particularly preferably 3 to 10 free-radically polymerizable olefinic double bonds. The polymerizable double bonds may, for example, be present in the form of (meth)acryloyl, vinyl, allyl, maleate and/or fumarate groups. The term “(meth)acryl” used in the present description and the claims means acryl and/or methacryl. The free-radically polymerizable double bonds are particularly preferably present in the form of (meth)acryloyl groups. Examples of such prepolymers are in particular (meth)acryloyl-functional (meth)acrylic copolymers, polyurethane (meth)acrylates, polyester (meth)acrylates, unsaturated polyesters, polyether (meth)acrylates, silicone (meth)acrylates and epoxy resin (meth)acrylates. The number average molar mass Mn of these compounds may, for example, be from 500 to 10,000 g/mol, preferably from 500 to 5000 g/mol. The binders A1 may be used individually or in combination.

All the number-average molar mass data stated in the present description and the claims are number-average molar masses determined or to be determined by gel permeation chromatography (GPC; divinylbenzene-crosslinked polystyrene as the immobile phase, tetrahydrofuran as the liquid phase, polystyrene standards).

Apart from the free-radically polymerizable olefinic double bonds, the binders A1 may also contain further functional, in particular crosslinkable, functional groups. Members of the resultant subgroup of binders A1 are denoted in the remainder of the description and in the claims as binders A1′. The binders A1′ may be present in the coating compositions in combination with binders A1 containing no further crosslinkable functional groups. The further crosslinkable functional groups are in particular functional groups crosslinkable by condensation or addition reactions. Examples which may in particular be mentioned in this connection are hydroxyl groups. If the coating compositions contain binders A1′, they generally also contain at least one crosslinking agent C with functional groups complementary to the crosslinkable groups of the binders A1′. For example, coating compositions containing binders A1′ comprising hydroxyl groups may contain as crosslinking agent(s) C conventional crosslinking agents known to the person skilled in the art for coating systems based on OH-functional binders, for example, transesterification crosslinking agents; free or blocked polyisocyanate crosslinking agents; amino resin crosslinking agents, such as, melamine-formaldehyde resins; and/or trisalkoxycarbonyl aminotriazine crosslinking agents.

When binders A1 are mentioned in this description and in the claims, binders of the subgroup A1′ are of course also included, except that the meaning is obviously limited to those binders A1 which, apart from the free-radically polymerizable olefinic double bonds, contain no further functional groups, in particular no crosslinkable functional groups.

The reactive diluents A2 are free-radically polymerizable low molecular weight compounds with a molar mass below 500 g/mol. The reactive diluents A2 may be mono-, di- or polyunsaturated. Examples of monounsaturated reactive diluents A2 are (meth)acrylic acid and the (cyclo)alkyl esters thereof, maleic acid and the semi-esters thereof, vinyl acetate, vinyl ethers, substituted vinyl ureas, styrene, vinyltoluene. Examples of diunsaturated reactive diluents A2 are di(meth)acrylates, such as, polyethylene glycol di(meth)acrylate, 1,3-butanediol di(meth)acrylate, vinyl (meth)acrylate, allyl (meth)acrylate, divinylbenzene, dipropylene glycol di(meth)acrylate, and hexanediol di(meth)acrylate. Examples of polyunsaturated reactive diluents A2 are glycerol tri(meth)acrylate, and trimethylolpropane tri(meth)acrylate. The reactive diluents A2 may be used individually or in combination.

Like the binders A1 in the form of representatives of subgroup A1′, the reactive diluents A2 may also contain, apart from the free-radically polymerizable olefinic double bonds, further thermally crosslinkable functional groups. Members of the resultant subgroup of reactive diluents A2 are denoted in the remainder of the description and in the claims as reactive diluents A2′. The reactive diluents A2′ may be present in the coating compositions in combination with reactive diluents A2 containing no further crosslinkable functional groups. The further crosslinkable functional groups are in particular functional groups crosslinkable by condensation or addition reactions. Examples, which may in particular be mentioned in this connection, are hydroxyl groups. If the coating compositions contain reactive diluents A2′, they generally also contain at least one crosslinking agent C with functional groups complementary to the crosslinkable groups of the reactive diluents A2′. For example, coating compositions containing reactive diluents A2′ comprising hydroxyl groups may contain as crosslinking agent C conventional crosslinking agents known to the person skilled in the art for coating systems based on OH-functional binders, for example, those crosslinking agents already mentioned in relation to the description of the binders A1′. Examples of reactive diluents A2′ with hydroxyl groups are compounds, such as, hydroxyalkyl (meth)acrylates, glycerol mono- and di(meth)acrylate and trimethylolpropane mono- and di(meth)acrylate.

When reactive diluents A2 are mentioned in this description and in the claims, reactive diluents of the subgroup A2′ are of course also included, except that the meaning is obviously limited to those reactive diluents A2 which, apart from the free-radically polymerizable olefinic double bonds, contain no further functional groups, in particular no crosslinkable functional groups.

The polyurethane resins B (not to be confused with possible type A polyurethane resins) comprise free-radically polymerizable olefinic double bonds. They are present in the coating compositions according to the invention as particles and exhibit a melting temperature of 40 to 160° C., in particular of 60 to 160° C. The melting temperatures are not in general sharp melting points, but instead the upper end of melting ranges with a breadth of, for example, 30 to 120° C. The melting ranges and thus, the melting temperatures may be determined, for example, by DSC (differential scanning calorimetry) at heating rates of 10 K/min.

The polyurethane resins B are insoluble or virtually insoluble in the coating compositions and are present therein as particles. The polyurethane resins B are only very slightly, if at all, soluble in organic solvents conventional in coatings, the solubility amounting, for example, to less than 10, in particular less than 5 g per litre of butyl acetate at 20° C.

In particular, the at least one polyurethane resin B curable by free-radical polymerization of olefinic double bonds is polyurethane resins with (meth)acryloyl groups and melting temperatures of 40 to 160° C., preferably of 60 to 160° C.

The production of polyurethane resins B with (meth)acryloyl groups is known to the person skilled in the art; in particular, they may be produced by reacting polyol(s) with polyisocyanate(s) in excess and reacting the excess free isocyanate groups with one or more hydroxyalkyl (meth)acrylates. Polyols suitable for the production of the polyurethane resins B with (meth)acryloyl groups are not only polyols in the form of low molar mass compounds defined by empirical and structural formula but also oligomeric or polymeric polyols with number-average molar masses of, for example, up to 800, for example, corresponding hydroxyl-functional polyethers, polyesters or polycarbonates; low molar mass polyols defined by an empirical and structural formula are, however, preferred. The person skilled in the art selects the nature and proportion of the polyisocyanates, the polyols and the hydroxyalkyl (meth)acrylates for the production of polyurethane resins B with (meth)acryloyl groups in such a manner that polyurethane resins B with (meth)acryloyl groups with the above-mentioned melting temperatures and the above-mentioned solubility behavior are obtained.

The polyurethane resins B with (meth)acryloyl groups may be produced in the presence of a suitable organic solvent (mixture), which, however, makes it necessary to isolate the polyurethane resins B with (meth)acryloyl groups obtained in this manner or remove the solvent therefrom. Preferably the production of the polyurethane resins B with (meth)acryloyl groups is, however, carried out without solvent and without subsequent purification operations.

In a first preferred embodiment, the polyurethane resins B with (meth)acryloyl groups are polyurethane di(meth)acrylates which can be prepared by reacting 1,6-hexane diisocyanate with a diol component and with at least one hydroxy-C2-C4-alkyl (meth)acrylate, preferably hydroxy-C2-C4-alkyl acrylate, in the molar ratio x:(x-1):2, wherein x means any desired value from 2 to 6, preferably, from 2 to 4, and the diol component is one single diol, in particular, one single (cyclo)aliphatic diol with a molar mass in the range of 62 to 600, or a combination of diols, preferably two to four, in particular, two or three diols, wherein, in the case of a diol combination each of the diols preferably constitutes at least 10 mol % of the diols of the diol component. In the case of a diol combination, it is preferred, that at least 70 mol %, in particular, 100 mol % of the diols are (cyclo)aliphatic diols, each with a molar mass in the range of 62 to 600.

The term “(cyclo)aliphatic” used in the present description and the claims encompasses cycloaliphatic, linear aliphatic, branched aliphatic and cycloaliphatic with aliphatic residues. Diols differing from (cyclo)aliphatic diols accordingly comprise aromatic or araliphatic diols with aromatically and/or aliphatically attached hydroxyl groups. One example is bisphenol A. Diols differing from (cyclo)aliphatic diols may furthermore comprise oligomeric or polymeric diols with number-average molar masses of, for example, up to 800, for example, corresponding polyether, polyester or polycarbonate diols.

1,6-hexane diisocyanate, diol component and the at least one hydroxy-C2-C4-alkyl (meth)acrylate are reacted stoichiometrically with one another in the molar ratio x mol 1,6-hexane diisocyanate:x-1 mol diol:2 mol hydroxy-C2-C4-alkyl (meth)acrylate, wherein x means any desired value from 2 to 6, preferably from 2 to 4.

One single diol, in particular, one single (cyclo)aliphatic diol with a molar mass in the range of 62 to 600 is used as the diol component. It is also possible to use a combination of diols, preferably two to four, in particular, two or three diols, wherein each of the diols preferably constitutes at least 10 mol % of the diols of the diol component and wherein it is further preferred, that at least 70 mol %, in particular 100 mol % of the diols are (cyclo)aliphatic diols, each with a molar mass in the range of 62 to 600.

In the case of the diol combination, the diol component may be introduced as a mixture of its constituent diols or the diols constituting the diol component may be introduced individually into the synthesis. It is also possible to introduce a proportion of the diols as a mixture and to introduce the remaining proportion(s) in the form of pure diol.

Examples of diols which are possible as one single diol of the diol component are ethylene glycol, the isomeric propane- and butanediols, 1,5-pentanediol, 1,6-hexanediol, 1,10-decanediol, 1,12-dodecanediol, 1,4-cyclohexanedimethanol, hydrogenated bisphenol A and dimer fatty alcohol.

Examples of diols which are possible as constituent of the diol component are telechelic (meth)acrylic polymer diols, polyester diols, polyether diols, polycarbonate diols, each with a number-average molar mass of, for example, up to 800 as representatives of oligomeric or polymeric diols, bisphenol A as a representative of low molar mass non-(cyclo)aliphatic diols defined by empirical and structural formula and ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol, and dimer fatty alcohol as representatives of (cyclo)aliphatic diols defined by empirical and structural formula with a low molar mass in the range of 62 to 600.

Preferably, only one hydroxy-C2-C4-alkyl (meth)acrylate is used. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates; the acrylate compound is preferred in each case.

1,6-hexane diisocyanate, the diol(s) of the diol component and the at least one hydroxy-C2-C4-alkyl (meth)acrylate are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. For example, 1,6-hexane diisocyanate may be reacted initially with hydroxy-C2-C4-alkyl (meth)acrylate and then with the diol(s) of the diol component or initially with the diol(s) of the diol component and then with hydroxy-C2-C4-alkyl (meth)acrylate. However, the diol component may, for example, also be divided into two or more portions, for example, also into the individual diols, for example, such that 1,6-hexane diisocyanate is reacted initially with part of the diol component before further reaction with hydroxy-C2-C4-alkyl (meth)acrylate and finally with the remaining proportion of the diol component. The individual reactants may in each case be added in their entirety or in two or more portions. The reaction is exothermic and proceeds at a temperature above the melting temperature of the reaction mixture, but below a temperature, which results in free-radical polymerization of the (meth)acrylate double bonds. The reaction temperature is, for example, 60 to 120° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethane di(meth)acrylates are obtained. When low molar mass diols defined by empirical and structural formula are used for synthesis of the polyurethane di(meth)acrylates their molar masses calculated with hydroxyethyl acrylate as the only representative of hydroxy-C2-C4-alkyl (meth)acrylates are in the range of 630 or above, for example, up to 2000. The polyurethane di(meth)acrylates assume the form of a mixture exhibiting a molar mass distribution. The polyurethane di(meth)acrylates do not, however, require working up and may be used directly as polyurethane resins B with (meth)acryloyl groups. Their melting temperatures are in particular in the range from 60 to 120° C.

In a second preferred embodiment, the polyurethane resins B with (meth)acryloyl groups are polyurethane di(meth)acrylates which can be prepared by reacting a diisocyanate component, a diol component and at least one hydroxy-C2-C4-alkyl (meth)acrylate, preferably, hydroxy-C2-C4-alkyl acrylate, in the molar ratio x:(x-1):2, wherein x means any desired value from 2 to 6, preferably, from 2 to 4, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein each diol of the diol component preferably forms at least 10 mol % within the diol component, and wherein the mol % of the respective diols add up to 100 mol %.

The diisocyanate component, the diol component and the at least one hydroxy-C2-C4-alkyl (meth)acrylate are reacted stoichiometrically with one another in the molar ratio x mol diisocyanate:x-1 mol diol:2 mol hydroxy-C2-C4-alkyl (meth)acrylate, wherein x represents any value from 2 to 6, preferably from 2 to 4.

50 to 80 mol % of the diisocyanate component is formed by 1,6-hexane diisocyanate, and 20 to 50 mol % by one or two diisocyanates selected from the group consisting of toluylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein if two diisocyanates are selected, each diisocyanate forms at least 10 mol % of the diisocyanates of the diisocyanate component. Preferably, the diisocyanate or the two diisocyanates, forming in total 20 to 50 mol % of the diisocyanate component, are selected from dicyclohexylmethane diisocyanate, isophorone diisocyanate, trimethylhexane diisocyanate, cyclohexane diisocyanate, cyclohexanedimethylene diisocyanate and tetramethylenexylylene diisocyanate.

The diol component consists to an extent of 20 to 100 mol % of at least one linear aliphatic alpha,omega-C2-C12-diol and to an extent of 0 to 80 mol % of at least one diol differing from linear aliphatic alpha,omega-C2-C12-diols. The diol component preferably consists of no more than four different diols, in particular, only of one to three diols. In the case of only one diol, it accordingly comprises a linear aliphatic alpha,omega-C2-C12-diol. In the case of a combination of two, three or four diols, the diol component consists to an extent of 20 to 100 mol %, preferably of 80 to 100 mol %, of at least one linear aliphatic alpha,omega-C2-C12-diol and to an extent of 0 to 80 mol %, preferably of 0 to 20 mol % of at least one diol differing from linear aliphatic alpha,omega-C2-C12-diols and preferably, also from alpha,omega-diols with more than 12 carbon atoms. The at least one diol differing from linear aliphatic alpha,omega-C2-C12-diols and preferably, also from alpha,omega-diols with more than 12 carbon atoms comprises in particular (cyclo)aliphatic diols defined by empirical and structural formula and with a low molar mass in the range of 76 to 600. The proportion of possible non-(cyclo)aliphatic diols preferably amounts to no more than 30 mol % of the diols of the diol component. In the case of a diol combination, each diol preferably makes up at least 10 mol % of the diol component.

Preferably, the diol component does not comprise any non-(cyclo)aliphatic diols. Most preferably, it does not comprise any diols that are different from linear aliphatic alpha,omega-C2-C12-diols, but rather consists of one to four, preferably, one to three, and in particular, only one linear aliphatic alpha,omega-C2-C12-diol.

In the case of the diol combination, the diol component may be introduced as a mixture of its constituent diols or the diols constituting the diol component may be introduced individually into the synthesis. It is also possible to introduce a proportion of the diols as a mixture and to introduce the remaining proportion(s) in the form of pure diol.

Examples of linear aliphatic alpha,omega-C2-C12-diols that may be used as one single diol or as constituent of the diol component are ethylene glycol, 1,3-propanediol, 1,4-butanediol, 1,5-pentanediol, 1,6-hexanediol, 1,10-decanediol and 1,12-dodecanediol.

Examples of diols that are different from linear aliphatic alpha,omega-C2-C12-diols and may be used in the diol component are telechelic (meth)acrylic polymer diols, polyester diols, polyether diols, polycarbonate diols, each with a number-average molar mass of, for example, up to 800 as representatives of oligomeric or polymeric diols, bisphenol A as a representative of low molar mass non-(cyclo)aliphatic diols defined by empirical and structural formula and those isomers of propanediol and butanediol that are different from the isomers of propanediol and butanediol specified in the preceding paragraph, as well as, neopentyl glycol, butyl ethyl propanediol, the isomeric cyclohexanediols, the isomeric cyclohexanedimethanols, hydrogenated bisphenol A, tricyclodecanedimethanol, and dimer fatty alcohol as representatives of (cyclo)aliphatic diols defined by empirical and structural formula with a low molar mass in the range of 76 to 600.

Preferably, only one hydroxy-C2-C4-alkyl (meth)acrylate is used. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates; the acrylate compound is preferred in each case.

The diisocyanates of the diisocyanate component, the diol(s) of the diol component and the at least one hydroxy-C2-C4-alkyl (meth)acrylate are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. For example, the diisocyanates of the diisocyanate component may be reacted initially with hydroxy-C2-C4-alkyl (meth)acrylate and then with the diol(s) of the diol component or initially with the diol(s) of the diol component and then with hydroxy-C2-C4-alkyl (meth)acrylate. However, the diol component may, for example, also be divided into two or more portions, for example, also into the individual diols, for example, such that the diisocyanates of the diisocyanate component are reacted initially with part of the diol component before further reaction with hydroxy-C2-C4-alkyl (meth)acrylate and finally with the remaining proportion of the diol component. In a very similar manner, however, the diisocyanate component may, for example, also be divided into two or more portions, for example, also into the individual diisocyanates, for example, such that the diol component and hydroxy-C2-C4-alkyl (meth)acrylate are reacted initially with part of the diisocyanate component and finally with the remaining proportion of the diisocyanate component. The individual reactants may in each case be added in their entirety or in two or more portions. The reaction is exothermic and proceeds at a temperature above the melting temperature of the reaction mixture, but below a temperature, which results in free-radical polymerization of the (meth)acrylate double bonds. The reaction temperature is, for example, 60 to 120° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethane di(meth)acrylates are obtained. When low molar mass diols defined by empirical and structural formula are used for synthesis of the polyurethane di(meth)acrylates their molar masses calculated with hydroxyethyl acrylate as the only representative of hydroxy-C2-C4-alkyl (meth)acrylates are in the range of 628 or above, for example, up to 2000. The polyurethane di(meth)acrylates assume the form of a mixture exhibiting a molar mass distribution. The polyurethane di(meth)acrylates do not, however, require working up and may be used directly as polyurethane resins B with (meth)acryloyl groups. Their melting temperatures are in particular in the range from 60 to 120° C.

In a third preferred embodiment, the polyurethane resins B with (meth)acryloyl groups are polyurethane (meth)acrylates which can be prepared by reacting a trimer of a (cyclo)aliphatic diisocyanate, 1,6-hexanediisocyanate, a diol component and at least one hydroxy-C2-C4-alkyl (meth)acrylate, preferably hydroxy-C2-C4-alkyl acrylate, in the molar ratio 1:x:x:3, wherein x means any desired value from 1 to 6, preferably, from 1 to 3, wherein the diol component is one single linear aliphatic alpha,omega-C2-C12-diol or a combination of two to four, preferably, two or three, (cyclo)aliphatic diols, wherein in the case of diol combination, each of the diols makes up at least 10 mol % of the diols of the diol combination and the diol combination consists of at least 80 mol % of at least one linear aliphatic alpha,omega-C2-C12-diol.

The trimer of the (cyclo)aliphatic diisocyanate, 1,6-hexanediisocyanate, the diol component and the at least one hydroxy-C2-C4-alkyl (meth)acrylate are reacted stoichiometrically with one another in the molar ratio 1 mol trimer of the (cyclo)aliphatic diisocyanate:x mol 1,6-hexanediisocyanate:x mol diol:3 mol hydroxy-C2-C4-alkyl (meth)acrylate, wherein x represents any value from 1 to 6, preferably from 1 to 3.

The trimer of the (cyclo)aliphatic diisocyanate is polyisocyanates of the isocyanurate type, prepared by trimerization of a (cyclo)aliphatic diisocyanate. Appropriate trimerization products derived, for example, from 1,4-cyclohexanedimethylenediisocyanate, in particular, from isophorondiisocyanate and more particularly, from 1,6-hexanediisocyanate, are suitable. The industrially obtainable isocyanurate polyisocyanates generally contain, in addition to the pure trimer, i.e., the isocyanurate made up of three diisocyanate molecules and comprising three NCO functions, isocyanate-functional secondary products with a relatively high molar mass. Products with the highest possible degree of purity are preferably used. In each case, the trimers of the (cyclo)aliphatic diisocyanates obtainable in industrial quality are regarded as pure trimer irrespective of their content of said isocyanate-functional secondary products with respect to the molar ratio of 1 mol trimer of the (cyclo)aliphatic diisocyanate:x mol 1,6-hexanediisocyanate:x mol diol:3 mol hydroxy-C2-C4-alkyl (meth)acrylate.

One single linear aliphatic alpha,omega-C2-C12-diol or combinations of two to four, preferably of two or three, (cyclo)aliphatic diols are used as the diol component. The diol combination preferably consists of two to four, in particular, two or three, linear aliphatic alpha,omega-C2-C12-diols.

Examples of one single linear aliphatic alpha,omega-C2-C12-diol or linear aliphatic alpha,omega-C2-C12-diols which can be used within the diol combination are ethylene glycol, 1,3-propanediol, 1,4-butanediol, 1,5-pentanediol, 1,6-hexanediol, 1,10-decanediol and 1,12-dodecanediol.

Examples of (cyclo)aliphatic diols which can be used within the diol combination in addition to the at least one linear aliphatic alpha,omega-C2-C12-diol making up at least 80 mol % of the diol combination are the further isomers of propane and butane diol, different from the isomers of propane and butane diol cited in the preceding paragraph, and neopentylglycol, butylethylpropanediol, the isomeric cyclohexane diols, the isomeric cyclohexanedimethanols, hydrogenated bisphenol A and tricyclodecaned imethanol.

In the case of the diol combination, the mixture of the diols making up the combination can be used in the synthesis process or the diols making up the diol combination are each used individually in the synthesis. It is also possible to use a portion of the diols as a mixture and the remaining fraction(s) in the form of pure diol.

In the case of the diol combination, preferred diol combinations totalling 100 mol % in each case are combinations of 10 to 90 mol % 1,3-propanediol with 90 to 10 mol % 1,5-pentanediol, 10 to 90 mol % 1,3-propanediol with 90 to 10 mol % 1,6-hexanediol and 10 to 90 mol % 1,5-pentanediol with 90 to 10 mol % 1,6-hexanediol.

Preferably, only one hydroxy-C2-C4-alkyl (meth)acrylate is used. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates; the acrylate compound is preferred in each case.

The trimer of the (cyclo)aliphatic diisocyanate, 1,6-hexane-diisocyanate, the diol component and the at least one hydroxy-C2-C4-alkyl (meth)acrylate are preferably reacted together in the absence of solvents. The reactants may here all be reacted together simultaneously or in two or more synthesis stages. Synthesis procedures in which the hydroxy-C2-C4-alkyl (meth)acrylate or the diol component and the trimer of the (cyclo)aliphatic diisocyanate alone are reacted with one another are preferably avoided. When the synthesis is performed in multiple stages, the reactants may be added in the most varied order, for example, also in succession or in alternating manner. For example, 1,6-hexane diisocyanate may be reacted initially with a mixture of diol component and hydroxy-C2-C4-alkyl (meth)acrylate and then with the trimer of the (cyclo)aliphatic diisocyanate or a mixture of the isocyanate-functional components with the diol component and hydroxy-C2-C4-alkyl (meth)acrylate or a mixture of the isocyanate-functional components may be reacted initially with hydroxy-C2-C4-alkyl (meth)acrylate and then with the diol component. In the case of a diol combination, the diol component may, for example, also be divided into two or more portions, for example, also into the individual (cyclo)aliphatic diols. The individual reactants may in each case be added in their entirety or in two or more portions. The reaction is exothermic and proceeds at a temperature above the melting temperature of the reaction mixture, but below a temperature, which results in free-radical polymerization of the (meth)acrylate double bonds. The reaction temperature is, for example, 60 to 120° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvents is complete and the reaction mixture has cooled, solid polyurethane (meth)acrylates with number average molar masses in the range of 1,500 to 4,000 are obtained. The polyurethane (meth)acrylates do not require working up and may be used directly as polyurethane resins B with (meth)acryloyl groups. Their melting temperatures are in particular in the range from 60 to 120° C.

The at least one polyurethane resin B is present in particulate form, in particular, in the form of particles with a non-spherical shape, in the coating compositions. The average particle size (mean particle diameter) of the B particles determined by means of laser diffraction is, for example, 1 to 100 μm. The B particles may be formed by grinding (milling) of the at least one solid polyurethane resin B; for example, conventional powder coat production technology may be used for that purpose. The B particles may either be stirred or mixed as a ground powder into the per se liquid coating composition or liquid constituents thereof, wherein it is possible subsequently to perform additional wet grinding or dispersing of the B particles, for example, by means of a bead mill, in the resultant suspension.

A further and preferred method for forming the B particles involves hot dissolution of the at least one polyurethane resin B in a dissolution medium and subsequent B particle formation during and/or after cooling, in particular, dissolving the at least one polyurethane resin B in a proportion or the entirety of component A, in particular in a binder A1, with heating to the melting temperature or above, for example, to temperatures of 60 to above 160° C., whereupon the B particles may form during and/or after the subsequent cooling. The component A used as dissolution medium for the at least one polyurethane resin B may here be present as such, in liquid or molten form, or as a solution in organic solvent(s). Thorough mixing or stirring is preferably performed during cooling. If the coating compositions according to the invention contain organic solvents, dissolution of the at least one polyurethane resin B may also be performed with heating in organic solvent, wherein the formation of the B particles, which proceeds during and/or after the subsequent cooling, may proceed in the solvent itself or after mixing of the resultant, as yet uncooled solution with component A. By using the method of hot dissolution and subsequent B particle formation during and/or after cooling, it is in particular possible to produce B particles with average particle sizes at the lower end of the range of average particle sizes, for example, in the range of 1 to 50 μm, in particular 1 to 30 μm.

As already stated, the coating compositions may contain one or more crosslinking agents C. These are then dual-cure coating compositions which, apart from curing by free-radical polymerization of olefinic double bonds of components A and B, may be cured by at least one further chemical curing mechanism involving the at least one crosslinking agent C, i.e., at least one crosslinking mechanism different from free-radical polymerization of olefinic double bonds, for example, addition and/or condensation reactions. If the coating compositions contain no crosslinking agent(s) C, they are mono-cure coating compositions.

The coating compositions may contain one or more further components D which contribute towards the resin solids content. The phrase “components D” encompasses resins without free-radically polymerizable olefinic double bonds and low molecular weight compounds with functional groups, but likewise without free-radically polymerizable olefinic double bonds. Examples are physically drying resins, which cannot be cured either by free-radical polymerization of olefinic double bonds or, as in the case of coating compositions of the dual-cure type, by other chemical means. In the case of coating compositions of the dual-cure type, components D may, for example, also be resins other than components A and B or compounds of a low molecular weight defined by the empirical formula, in each case having functional groups reactive with the at least one crosslinking agent C. Examples of functional groups are hydroxyl groups which may react with the functional groups of the crosslinking agent(s) C, i.e., in the present case of hydroxyl groups, components D are, for example, polymer polyols, such as, polyester polyols or hydroxy-functional (meth)acrylic copolymers and/or polyols such as, for example, hexanediol, trimethylolpropane, glycerol. Examples of crosslinking agents C which may be combined with components D of the polyol type are transesterification crosslinking agents; free or blocked polyisocyanate crosslinking agents; amino resin crosslinking agents, such as, melamine-formaldehyde resins; and/or trisalkoxycarbonyl aminotriazine crosslinking agents.

In the case of the coating compositions according to the invention, a distinction must thus be made between mono-cure coating compositions curable by free-radical polymerization of the olefinic double bonds of components A and B, and dual-cure coating compositions which may additionally be cured by a further chemical curing mechanism and contain one or more crosslinking agents C and crosslinking partners for the crosslinking agent(s) C in the form of suitable compounds of the type A1′ and/or A2′ and/or D. Physically drying binders of type D may be present in both mono-cure and dual-cure type coating compositions according to the invention. In the case of coating compositions which are curable exclusively by free-radical polymerization of the olefinic double bonds of components A and B and contain neither components C nor D, the binder solids content and resin solids content are identical.

The coating compositions according to the invention may be thermally curable coating compositions (curable on supply of thermal energy, for example, heating). Preferably, however, the coating compositions are curable by UV irradiation and optionally, additionally thermally curable. While thermally curable coating compositions contain at least one thermally cleavable free-radical initiator, the coating compositions, which are curable by UV irradiation, contain at least one photoinitiator. Coating compositions that are curable by UV irradiation and are additionally thermally curable by at least one thermal crosslinking mechanism different from free-radical polymerization of olefinic double bonds, i.e., by condensation and/or addition reactions, also contain at least one photoinitiator.

Examples of thermally cleavable free-radical initiators are azo compounds, peroxide compounds and C-C-cleaving initiators.

The preferred coating compositions according to the invention curable by UV irradiation and optionally, additionally by supply of thermal energy contain one or more photoinitiators, for example, in total proportions of 0.1 to 5 wt. %, preferably of 0.5 to 3 wt. %, relative to the resin solids content. Examples of photoinitiators are benzoin and derivatives thereof, acetophenone and derivatives thereof, such as, for example, 2,2-diacetoxyacetophenone, benzophenone and derivatives thereof, thioxanthone and derivatives thereof, anthraquinone, 1-benzoylcyclohexanol, and organophosphorus compounds, such as, for example, acyl phosphine oxides. The photoinitiators may be used individually or in combination.

It may be convenient for the B particles to contain the at least one photoinitiator or a proportion thereof. For example, photoinitiator may be introduced into the B particles by addition and incorporation into the molten polyurethane resin B and mechanical comminution, in particular grinding, as has already been mentioned above.

In general, the coating compositions according to the invention contain organic solvent(s) and then have a solids content of, for example, 40 to 95 wt. % and an organic solvent content of, for example, 5 to 60 wt. %; the sum of the wt. % of the solids content and the organic solvent content is here, for example, 90 to 100 wt. % (any possible difference in the corresponding range of above 0 to 10 wt. % to make up to the total of 100 wt. % is in general formed by volatile additives). The organic solvents are in particular conventional coating solvents, for example, glycol ethers, such as, butyl glycol, butyl diglycol, dipropylene glycol dimethyl ether, dipropylene glycol monomethyl ether, ethylene glycol dimethylether; glycol ether esters, such as, ethyl glycol acetate, butyl glycol acetate, butyl diglycol acetate, methoxypropyl acetate; esters, such as, butyl acetate, isobutyl acetate, amyl acetate; ketones, such as, methyl ethyl ketone, methyl isobutyl ketone, diisobutyl ketone, cyclohexanone, isophorone; alcohols, such as, methanol, ethanol, propanol, butanol; and aromatic hydrocarbons, such as, xylene, Solvesso® 100 (mixture of aromatic hydrocarbons with a boiling range from 155° C. to 185° C.), Solvesso® 150 (mixture of aromatic hydrocarbons with a boiling range from 182° C. to 202° C.) and aliphatic hydrocarbons.

Apart from the initiators and optional solvents already stated, the coating compositions may contain further conventional coating additives, for example, inhibitors, levelling agents, wetting agents, anticratering agents, antioxidants and light stabilizers. The additives are used in conventional amounts known to the person skilled in the art.

The coating compositions may also contain transparent pigments, color-imparting and/or special effect-imparting pigments and/or fillers, for example, corresponding to a ratio by weight of pigment plus filler:resin solids content in the range from 0:1 to 2:1. Suitable color-imparting pigments are any conventional coating pigments of an organic or inorganic nature. Examples of inorganic or organic color-imparting pigments are titanium dioxide, iron oxide pigments, carbon black, azo pigments, phthalocyanine pigments, quinacridone pigments and pyrrolopyrrole pigments. Examples of special effect pigments are metal pigments, for example, of aluminum, copper or other metals, interference pigments, such as, for example, metal oxide-coated metal pigments, for example, iron oxide-coated aluminum, coated mica, such as, for example, titanium dioxide-coated mica, graphite effect-imparting pigments, iron oxide in flake form, liquid crystal pigments, coated aluminum oxide pigments, and coated silicon dioxide pigments. Examples of fillers are silicon dioxide, aluminum silicate, barium sulfate, calcium carbonate and talc.

The coating compositions may be used for the production of single-layer coatings or for the production of one or more coating layers within a multilayer coating, such as, in particular, an automotive multilayer coating, either on an automotive body or on an automotive body part. This may relate to both original and repair coating applications. The coating compositions may in particular be used in pigmented form for the production of a primer surfacer layer or in pigment-free form for the production of an outer clear top coat layer or a transparent sealing layer of a multilayer coating. They may, for example, be used for the production of a clear top coat layer on a previously applied color-imparting and/or special effect-imparting predried base coat layer.

The coating compositions may be applied by means of conventional application methods, in particular by spraying onto any desired uncoated or precoated substrates, for example, of metal or thermally stable plastics.

After application, the coating layer is first of all heated briefly, for example, for 5 to 15 minutes, for example, to temperatures of 60 to 180° C. Any optionally present volatile component, in particular, organic solvents may be vaporized during such heating and the B particles are fused and may become an integral part of the resin matrix.

If the coating compositions are thermally curable coating compositions, curing may proceed during said heating and/or on further supply of thermal energy by dissociation of the free-radical initiator contained therein into free radicals and free-radical polymerization of the olefinic double bonds and, in the case of coating compositions of the dual-cure type, by an additional chemical crosslinking mechanism. The further supply of thermal energy may proceed, for example, by further heating, for example, to higher temperatures of, for example, up to 200° C.

In the case of the preferred coating compositions curable by UV irradiation, once the coating layer has been heated, it is irradiated with UV radiation for the purpose of curing. On so doing, the photoinitiator(s) dissociate(s) into free-radicals and the olefinic double bonds of components A and B undergo free-radical polymerization.

UV irradiation may, for example, proceed in a belt unit fitted with one or more UV radiation emitters or the substrates and/or the UV radiation emitter(s) are moved relative to one another during irradiation. For example, the substrates may be moved through an irradiation tunnel fitted with one or more UV radiation emitters and/or a robot equipped with one or more UV radiation emitters may guide the UV radiation emitter(s) over the substrates.

UV irradiation may proceed in one or more temporally and optionally spatially separate steps. UV irradiation may take place continuously or discontinuously (in cycles).

The preferred source of radiation comprises UV radiation sources emitting in the wave length range from 180 to 420 nm, in particular from 200 to 400 nm. Examples of such continuously operating UV radiation sources are optionally doped high, medium and low pressure mercury vapor emitters and gas discharge tubes, such as, for example, low pressure xenon lamps. Discontinuous UV radiation sources may, however, also be used. These are preferably so-called high-energy flash devices (UV flash lamps for short). The UV flash lamps may contain a plurality of flash tubes, for example, quartz tubes filled with inert gas such as xenon. The UV flash lamps have an illuminance of, for example, at least 10 megalux, preferably from 10 to 80 megalux per flash discharge. The energy per flash discharge may be, for example, 1 to 10 kjoule.

The irradiation time with UV radiation when UV flash lamps are used as the UV radiation source may be, for example, in the range from 1 millisecond to 400 seconds, preferably from 4 to 160 seconds, depending on the number of flash discharges selected. The flashes may be triggered, for example, about every 4 seconds. Curing may take place, for example, by means of 1 to 40 successive flash discharges.

If continuous UV radiation sources are used, the irradiation time may be, for example, in the range from a few seconds to about 5 minutes, preferably less than 5 minutes.

The distance between the UV radiation sources and the surface to be irradiated may be, for example, 5 to 60 cm.

If the coating layer has been applied from dual-cure type coating compositions curable by UV irradiation and additionally by supply of thermal energy, thermal energy may be supplied in conventional manner, for example, by convection and/or infrared irradiation, to cure the coating layer by means of at least one additional thermal crosslinking mechanism different from free-radical polymerization of olefinic double bonds, i.e., condensation and/or addition reactions. This additional thermal curing may be performed before, during and/or after the UV irradiation.

The following examples illustrate the invention.

### EXAMPLES

pbw means parts by weight.

### Examples 1a to 1i

### Preparation of Polyurethane Diacrylates

Polyurethane diacrylates were produced by reacting 1,6-hexane diisocyanate with diols and hydroxyalkyl acrylate in accordance with the following general synthesis method:

1,6-hexane diisocyanate (HDI) was initially introduced into a 2 litre four-necked flask equipped with a stirrer, thermometer and column and 0.1 wt. % methylhydroquinone and 0.01 wt. % dibutyltin dilaurate, in each case relative to the initially introduced quantity of HDI, were added. The reaction mixture was heated to 60° C. Hydroxyalkyl acrylate was then apportioned in such a manner that the temperature did not exceed 80° C. The reaction mixture was stirred at 80° C. until the theoretical NCO content had been reached. Once the theoretical NCO content had been reached, the diols A, B, C were added one after the other, in each case in a manner such that a temperature of 75 to 120° C. was maintained. In each case, the subsequent diol was not added until the theoretical NCO content had been reached. The reaction mixture was stirred at 120° C. until no free isocyanate could be detected. The hot melt was then discharged and allowed to cool.

The melting behavior of the resultant polyurethane diacrylates was investigated by means of DSC (differential scanning calorimetry, heating 10 rate 10 K/min).

Examples 1a to 1i are shown in Table 1. The Table states which reactants were reacted together in what molar ratios and the final temperature of the melting process measured by DSC is stated in ° C.

TABLE 1

| | | | | | | | | | Final |
|---|---|---|---|---|---|---|---|---|---|
| | | Mols | | | | | | | temperature |
| | | Hydroxy- | | | | | | | of the |
| | Mols | alkyl | Mols | | Mols | | Mols | | melting |
| Example | HDI | acrylate | Diol A | | diol B | | Diol C | | process |
| 1a | 2 | 2 HEA | 0.8 | NPG | 0.2 | HEX | | | 90° C. |
| 1b | 3 | 2 HEA | 1.7 | NPG | 0.3 | HEX | | | 88° C. |
| 1c | 3 | 2 HEA | 1.5 | NPG | 0.5 | HEX | | | 99° C. |
| 1d | 4 | 2 HEA | 2.2 | NPG | 0.8 | HEX | | | 100° C. |
| 1e | 3 | 2 HEA | 1 | HBPA | 1 | HEX | | | 110° C. |
| 1f | 3 | 2 HEA | 1 | HBPA | 1 | DEC | | | 118° C. |
| 1g | 3 | 2 HBA | 0.7 | MPD | 0.7 | PENT | 0.6 | DEC | 117° C. |
| 1h | 3 | 2 HBA | 1 | CHDM | 1 | PROP | | | 118° C. |
| 1i | 3 | 2 HPA | 0.6 | HEX | 0.7 | PENT | 0.7 | PROP | 112° C. |

HDI: 1,6-hexane diisocyanate
HBA: 4-hydroxybutyl acrylate
HEA: hydroxyethyl acrylate
HPA: 2-hydroxypropyl acrylate
CHDM: 1,4-cyclohexanedimethanol
DEC: 1,10-decanediol
HBPA: hydrogenated bisphenol A
HEX: 1,6-hexanediol
MPD: 2-methyl-1,3-propanediol
NPG: neopentyl glycol
PENT: 1,5-pentanediol
PROP: 1,3-propanediol

### Example 2

### Preparation of a Polyurethane Diacrylate

HDI, IPDI (isophorone diisocyanate), HEA, NPG and PROP were reacted in the molar ration 3:1:2:2:1 as follows:

HDI and IPDI were initially introduced into a 2 litre four-necked flask equipped with a stirrer, thermometer and column and 0.1 wt. % methylhydroquinone and 0.01 wt. % dibutyltin dilaurate, in each case relative to the initially introduced quantity of diisocyanate, were added. The reaction mixture was heated to 60° C. HEA was then apportioned in such a manner that the temperature did not exceed 80° C. The reaction mixture was stirred at 80° C. until the theoretical NCO content had been reached. Once the theoretical NCO content had been reached, NPG and PROP were added one after the other, in each case in a manner such that a temperature of 75 to 120° C. was maintained. PROP was not added until the theoretical NCO content had been reached. The reaction mixture was stirred at 120° C. until no free isocyanate could be detected. The hot melt was then discharged and allowed to cool.

The melting behavior of the resultant polyurethane diacrylate was investigated by means of DSC (heating rate 10 K/min); the final temperature of the melting process was 110° C.

### Examples 3a to 3d

### Preparation of Polyurethane Acrylates

Polyurethane acrylates were produced by reacting a trimer of a (cyclo)aliphatic diisocyanate, HDI, diol component and hydroxyalkyl acrylate in accordance with the following general synthesis method:

A mixture of a trimer of a diisocyanate and HDI was initially introduced into a 2 litre four-necked flask equipped with a stirrer, thermometer and column and 0.1% by weight methylhydroquinone and 0.01% by weight dibutyl tin dilaurate, in each case based on the quantity of isocyanate introduced, were added. The reaction mixture was heated to 60° C. A mixture of hydroxyalkyl acrylate and diol(s) was then added such that 110° C. was not exceeded. The temperature was carefully increased to a maximum of 120° C. and the mixture stirred until no more free isocyanate could be detected. The hot melt was then discharged and allowed to cool.

The melting behavior of the resultant polyurethane acrylates was investigated by means of DSC (heating rate 10 K/min).

Examples 3a to 3d are shown in Table 2. The table states which reactants were reacted together and in which molar ratios and the final temperature of the melting process measured using DSC is indicated in ° C.

TABLE 2

| | Mols of | | Mols of | | | Final |
|---|---|---|---|---|---|---|
| | trimeric | Mols | hydroxyalkyl | Mols of | Mols of | temperature of the |
| Example | diisocyanate | of HDI | acrylate | diol A | diol B | melting process |
| 3a | 1 t-HDI | 3 | 3 HPA | 3 PROP | | 115° C. |
| 3b | 1 t-HDI | 2 | 3 HPA | 1 PROP | 1 HEX | 95° C. |
| 3c | 1 t-HDI | 2 | 3 HBA | 2 PENT | | 100° C. |
| 3d | 1 t-HDI | 3 | 3 HEA | 3 HEX | | 119° C. |

t-HDI; trimeric hexanediisocyanate, Desmodur ® N3600 from Bayer
cf. Table 1 for further abbreviations.

### Example 4

### Production of a Coating Composition for Comparison Purposes

A 40 wt. % solution of a urethane acrylate (calculated molar mass 1122, calculated functionality 3.14) in butyl acetate was produced by first dissolving 0.125 mol of NPG in butyl acetate at 65° C. 1 mol of t-HDI was then added at 65° C. and the batch was heated to 70° C. Once the exothermic reaction had come to an end, the reaction was continued at 80° C. until a constant NCO value was reached. 4-Methoxyphenol (inhibitor) and dibutyltin dilaurate (catalyst) were then added in a quantity of in each case 0.05 wt. %, relative to the whole batch. 2.75 mol of HBA were apportioned at 60° C. in such a manner that the temperature did not exceed 80° C. Once a NCO value of <0.1 had been reached, the solids content was then reduced with butyl acetate to a solids content of 40 wt. %.

97 pbw of this solution were in each case mixed with 0.1 pbw of a free-radically polymerizable silicone levelling additive, 1 pbw of a light stabilizer (HALS, hindered amine light stabilizer), 0.5 pbw of a benzotriazole-based UV absorber, 1 pbw of a photoinitiator from the group of alpha-hydroxyketones and 0.4 pbw of a photoinitiator from the group of acylphosphine oxides.

### Examples 5a to 5o

### Production of Coating Compositions According to the Invention

The solid polyurethane acrylate resins according to Examples 1a to 1i, 2 and 3a to 3d were in each case comminuted and ground and sieved by means of grinding and sieving methods conventional for the production of powder coatings and, in this manner, converted into polyurethane acrylate resin powders.

The polyurethane acrylate resin powders were blended into the coating composition of Example 4 in each case in the ratio 97.5 pbw of solvent-free urethane acrylate of Example 4: 2.5 pbw of polyurethane acrylate resin powder. To this end the polyurethane acrylate resin powders were dissolved in the 40 wt. % solution of the urethane acrylate in butyl acetate of Example 4 under heating above the melting temperature and stirring. On cooling and stirring the solid polyurethane acrylate resins precipitated. Thereafter the silicone levelling additive, the light stabilizer, the UV absorber and the two photoinitiators (compare Example 4) were added under stirring to obtain coating compositions 5a to 5o according to the invention.

The coating composition according to Example 4 and the coating compositions 5a to 5o produced as described were in each case sprayed onto steel test sheets as a wedge in a dry film thickness range of 20 to 70 μm and in each case suspended for 10 minutes at an object temperature of 140° C. in order to remove the solvent and cause the polyurethane acrylate resin particles to fuse and merge. The hot metal sheets were then exposed to UV radiation in order to cure the coating layers in a wedge-shaped gradient (medium pressure mercury vapor emitter with a power of 100 W/cm, object distance 14 cm, belt speed 1.5 m/min).

Cured, glossy coating layers were obtained in each case.

Comparative Example 4 and Examples 5a to 5o according to the invention are shown in Table 3. The Table shows the measured sag limits in μm.

TABLE 3

| | Added | |
|---|---|---|
| Examples | binder | Sag limits (μm) |
| 4 (Comparison) | ./. | 35 |
| 5a | 1a | 42 |
| 5b | 1b | 38 |
| 5c | 1c | 41 |
| 5d | 1d | 40 |
| 5e | 1e | 42 |
| 5f | 1f | 39 |
| 5g | 1g | 40 |
| 5h | 1h | 39 |
| 5i | 1i | 40 |
| 5k | 2 | 41 |
| 5l | 3a | 38 |
| 5m | 3b | 36 |
| 5n | 3c | 41 |
| 5o | 3d | 39 |

What is claimed is:

1. Non-aqueous, liquid coating compositions curable by free-radical polymerization of olefinic double bonds with a resin solids content consisting of 50 to 100 wt. % of a binder solids content curable by free-radical polymerization of olefinic double bonds, 0 to 30 wt. % of one or more crosslinking agents C and 0 to 50 wt. % of one or more components D, wherein the weight percentages add up to 100 wt. %, wherein the binder solids content consists of above 95 wt. % to 99.5 wt. % of one or more components A curable by free-radical polymerization of olefinic double bonds and 0.5 to below 5 wt. % of one or more polyurethane resins B curable by free-radical polymerization of olefinic double bonds, wherein the weight percentages of the at least one component A and the at least one polyurethane resin B add up to 100 wt. %, wherein the at least one component A is liquid and/or is present in dissolved form and wherein the at least one polyurethane resin B is present as particles having a melting temperature of 40 to 160° C.

2. The coating compositions of claim 1, wherein the solids content is 40 to 100 wt. % and consists of the resin solids content and the optional components: pigments, fillers and non-volatile additives.

3. The coating compositions of claim 2, wherein the solids content is 40 to 95 wt. %, the organic solvent content is 5 to 60 wt. % and the sum of the wt. % of the solids content and the organic solvent content is 90 to 100 wt. %.

4. The coating compositions of claim 1, wherein the at least one component A is selected from the group consisting of binders A1 and reactive diluents A2 and combinations thereof.

5. The coating compositions of claim 1, wherein the melting temperature of the at least one polyurethane resin B is the upper end of a 30 to 120° C. broad melting range.

6. The coating compositions of claim 1, wherein the solubility of the at least one polyurethane resin B is less than 10 g per litre of butyl acetate at 20° C.

7. The coating compositions of claim 1, wherein the average particle size of the B particles determined by means of laser diffraction is 1 to 100 μm.

8. The coating compositions of claim 1, wherein the B particles are formed by grinding of the at least one solid polyurethane resin B or by hot dissolution of the at least one polyurethane resin B in a dissolution medium and subsequent B particle formation during and/or after cooling.

9. The coating compositions of claim 1, wherein the at least one polyurethane resin B is polyurethane resins with (meth)acryloyl groups.

10. The coating compositions of claim 9, wherein the polyurethane resins with (meth)acryloyl groups are polyurethane di(meth)acrylates which are prepared by reacting 1,6-hexane diisocyanate with a diol component and with at least one hydroxy-C2-C4-alkyl (meth)acrylate in the molar ratio x:(x-1):2, wherein x means any desired value from 2 to 6 and the diol component is one single diol or a combination of diols.

11. The coating compositions of claim 9, wherein the polyurethane resins with (meth)acryloyl groups are polyurethane di(meth)acrylates which are prepared by reacting a diisocyanate component, a diol component and at least one hydroxy-C2-C4-alkyl (meth)acrylate in the molar ratio x:(x-1):2, wherein x means any desired value from 2 to 6, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, and wherein the mol % of the respective diols add up to 100 mol %.

12. The coating compositions of claim 9, wherein the polyurethane resins with (meth)acryloyl groups are polyurethane (meth)acrylates which are prepared by reacting a trimer of a (cyclo)aliphatic diisocyanate, 1,6-hexanediisocyanate, a diol component and at least one hydroxy-C2-C4-alkyl (meth)acrylate in the molar ratio 1:x:x:3, wherein x means any desired value from 1 to 6, wherein the diol component is one single linear aliphatic alpha,omega-C2-C12-diol or a combination of two to four (cyclo)aliphatic diols, wherein in the case of diol combination, each of the diols makes up at least 10 mol % of the diols of the diol combination and the diol combination consists of at least 80 mol % of at least one linear aliphatic alpha,omega-C2-C12-diol.

13. The coating compositions of claim 1, wherein the coating compositions are selected from the group consisting of thermally curable coating compositions containing at least one thermally cleavable free-radical initiator and coating compositions curable by UV irradiation containing at least one photoinitiator and coating compositions curable by UV irradiation and additionally thermally curable by at least one crosslinking mechanism different from free-radical polymerization of olefinic double bonds and containing at least one photoinitiator.

14. A process for the preparation of a coating layer, comprising the successive steps:
1) applying a coating layer from a coating composition of claim 1,
2) heating the coating layer so formed to vaporize optionally present volatile components and to fuse the B particles and
3) curing the coating layer by 3a) supply of thermal energy in case of a thermally curable coating composition or by 3b) UV irradiation in case of a coating composition curable by UV irradiation or by 3c) UV irradiation and supply of thermal energy in case of a coating composition curable by UV irradiation and additionally thermally curable by at least one crosslinking mechanism different from free-radical polymerization of olefinic double bonds.

15. The process of claim 14, wherein the coating layer is selected from the group consisting of a single-layer coating and a coating layer within a multilayer coating.

16. The process of claim 15, wherein the coating layer within the multilayer coating is an automotive multilayer coating on a substrate selected from the group consisting of automotive bodies and body parts.

17. The process of claim 16, wherein the coating layer is selected from the group consisting of a primer surfacer layer, an outer clear top coat layer and a transparent sealing layer.
